(19) United States
(12) Patent Application Publication
(10) Pub. No.: US 2022/0244393 A1
(43) Pub. Date: Aug. 4, 2022

(54) ELECTRONIC DEVICE AND METHOD FOR TIME-OF-FLIGHT MEASUREMENT

(71) Applicant: Sony Semiconductor Solutions Corporation, Kanagawa (JP)

(72) Inventors: Victor Belokonskiy, Zaventem (BE); Jeroen Hermans, Stuttgart (DE)

(73) Assignee: Sony Semiconductor Solutions Corporation, Kanagawa (JP)

(21) Appl. No.: 17/621,902

(22) PCT Filed: Jul. 8, 2020
(86) PCT No.: PCT/EP2020/069231

§ 371 Date: Dec. 22, 2021

(30) Foreign Application Priority Data
Jul. 9, 2019 (EP) 19185234.2

(51) Int. Cl. G01S 17/894; G01S 7/4915

(52) U.S. Cl. CPC G01S 17/894; G01S 7/4915

(57) ABSTRACT

Electronic device comprising circuitry configured to generate, during an exposure time, an in-pixel reference signal (m(t); 201), wherein the exposure time comprises one or more sub-exposures (203), each sub-exposure (203) comprising a set of multiple components (P1, P2, P3; P1, P2, P3, P4; P11, P12, P13, P14), each component having a respective predefined duration and each component providing a predefined acquisition phase; wherein the set of multiple components comprises one or more basic components (P3; P4; P12, P14) providing a predefined basic acquisition phase (Φ₀)> and at least two additional components (P1, P2; P1, P2, P3; P11, P13) providing respective predefined additional acquisition phases, each additional acquisition phase having a respective phase offset (ΔΦ) with respect to the basic acquisition phase (φ₀); wherein the durations (bₙ) and the phase offsets (Δφₙ) of the additional components (P1, P2; P1, P2, P3; P11, P13) are arranged such that, in total, the phase offsets (Δφₙ) of the additional components compensate (P1, P2; P1, P2, P3; P11, P13) each other.

### TECHNICAL FIELD

The present disclosure generally pertains to the field of electronic devices and methods for electronic devices, in particular to time-of-flight imaging.

### TECHNICAL BACKGROUND

A time-of-flight camera is a range imaging camera system that determines the distance of objects measuring the time-of-flight (ToF) of a light signal between the camera and the object for each point of the image. A time-of-flight camera thus receives a depth map of a scene. Generally, a time-of-flight camera has an illumination unit that illuminates a region of interest with modulated light, and a pixel array that collects light reflected from the same region of interest. As individual pixels collect light from certain parts of the scene, a time-of-flight camera may include a lens for imaging while maintaining a reasonable light collection area.

A typical ToF camera pixel develops a charge that represents a correlation between the illuminated light and the backscattered light. To enable the correlation between the illuminated light and the backscattered light, each pixel is controlled by a common demodulation input coming from a mixing driver. The demodulation input to the pixels is synchronous with an illumination block modulation.

Frequency aliasing is a well-known effect that appears when a signal is sampled at less than the double of the highest frequency contained in the signal (Nyquist-Shannon theorem). For example, for (indirect) ToF cameras, the frequency aliasing may result in a cyclic phase error (in the following “cyclic error” or “phase error”) of the depth or distance measurements, such that, in some embodiments, a calibration of the ToF camera may be needed.

Cyclic error calibration data may be acquired by capturing data from known objects positioned on known distances. For example, data captured from a planar surface may be positioned at a set of known positions in front of the ToF camera. Exploiting the known object shape and position, the known radial depth may be known in each pixel for each object position. Performing ToF capture and depth sensing for each object's position, a phase shift estimate may be obtained for each pixel (estimate of delay between transmitted and received light). These data are used to construct a model of measured phase versus true distance, which may be used at runtime to correct phases measured into distance estimates. Besides space requirements, aforementioned method of construction a measured phase versus true distance relation directly depends on the method used to estimate the phase of the correlation waveform's first harmonics. Different calibration curves need to be generated for modes using different number of components or different correlation waveform sampling schemes.

Although there exist cyclic error calibration techniques for time-of-flight cameras, it is generally desirable to provide better cyclic error calibration techniques or directly reduce cyclic error in depth acquisition.

### SUMMARY

According to a first aspect, the disclosure provides an electronic device comprising circuitry configured to generate, during an exposure time, an in-pixel reference signal, wherein the exposure time comprises one or more sub-exposures, each sub-exposure comprising a set of multiple components, each component having a respective predefined duration and each component providing a predefined acquisition phase; wherein the set of multiple components comprises one or more basic components providing a predefined basic acquisition phase, and at least two additional components providing respective predefined additional acquisition phases, each additional acquisition phase having a respective phase offset with respect to the basic acquisition phase; wherein the durations and the phase offsets of the additional components are arranged such that, in total, the phase offsets of the additional components compensate each other. According to a second aspect, the disclosure provides a time of flight camera comprising the circuitry of the first aspect.

According to a third aspect, the disclosure provides a method comprising: generating, during an exposure time, an in-pixel reference signal, wherein the exposure time comprises one or more sub-exposures, each sub-exposure comprising a set of multiple components, each component having a respective predefined duration and each component providing a predefined acquisition phase; wherein the set of multiple components comprises one or more basic components providing a predefined basic acquisition phase, and at least two additional components providing respective predefined additional acquisition phases, each additional acquisition phase having a respective phase offset with respect to the basic acquisition phase; wherein the durations and the phase offsets of the additional components are arranged such that, in total, the phase offsets of the additional components compensate each other. Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates schematically the basic operational principle of a time-of-flight (ToF) camera;

FIG. 2a illustrates as an embodiment, a modulation circuit for shifting a phase and changing a duty cycle of the modulation signal;

FIG. 2b illustrates as another embodiment, a modulation circuit for shifting a phase and changing a duty cycle of the modulation signal;

FIG. 3a illustrates schematically as an embodiment, a structure of the illumination modulation signal in a sub-exposure;

FIG. 3b illustrates schematically as another embodiment, a structure of the illumination modulation signal a sub-exposure;

FIG. 3c illustrates schematically as another embodiment, a structure of the illumination modulation signal a sub-exposure;

FIG. 4 graphically compares the frequency response of an ideal system, a real system, a high bandwidth system and a reduced bandwidth system;

FIG. 5 graphically compares the phase error of the illumination modulation signal as presented in FIG. 3a with two conventional structures of illumination modulation signal for the “high bandwidth” case;

FIG. 6 illustrates a graph indicating, for a high bandwidth system and a reduced bandwidth system, the optimal phase offset for the compensation components of the illumination modulation signal as presented in FIG. 3a in dependence of the duty cycle;

FIG. 7 illustrates a graph indicating, for a high bandwidth system and a reduced bandwidth system, the optimal compensation ratio of the illumination modulation signal as presented in FIG. 3a in dependence of the duty cycle;

FIG. 8 graphically represents the signal power loss of the illumination modulation signal as presented in FIG. 3a and of the “another known method” compared to the “duty cycle only” case;

FIG. 9 graphically compares the phase error of the illumination modulation signal as presented in FIG. 3a with two conventional structures of illumination modulation signal for the “reduced bandwidth” case;

FIG. 10 illustrates schematically, as another embodiment, a structure of an illumination modulation signal with four illumination waveform components with different phase offsets;

FIG. 11 illustrates schematically the resulting illumination modulation signal as obtained with the illumination modulation structure of FIG. 10;

FIG. 12 graphically compares the optimized phase error of the illumination modulation signal (compensation ratio of 1.0) as presented in FIG. 10 with two conventional structures of illumination modulation signal;

FIG. 13 graphically compares the optimized phase error of the illumination modulation signal (compensation ratio of 0.7) as presented in FIG. 10 with two conventional structures of illumination modulation signal; and

FIG. 14 graphically represents the signal power loss of the illumination modulation signal as presented in FIG. 10 and of the “another known method” compared to the “duty cycle only” case.

### DETAILED DESCRIPTION OF EMBODIMENTS

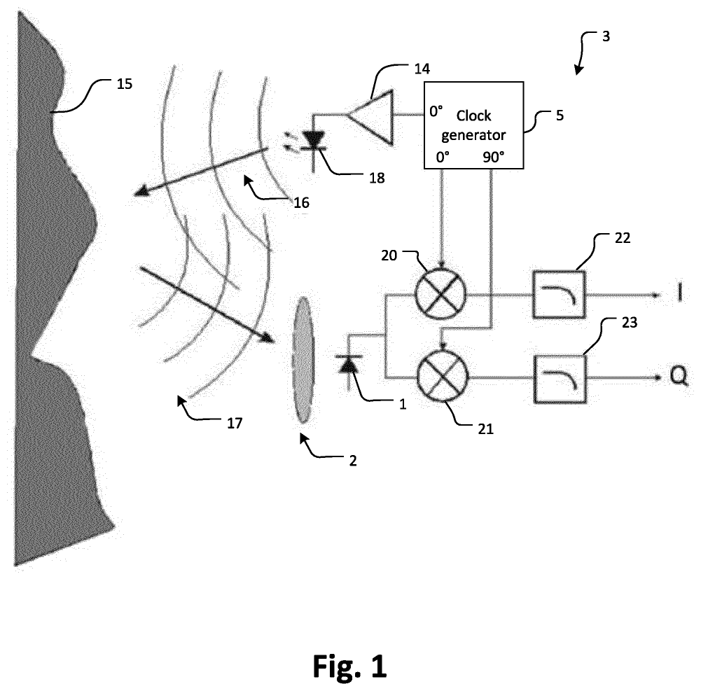

Before a detailed description of the embodiments under reference of FIG. 1, general explanations are made.

The embodiments described below provide an electronic device comprising circuitry configured to generate, during an exposure time, an in-pixel reference signal, wherein the exposure time comprises one or more sub-exposures, each sub-exposure comprising a set of multiple components, each component having a respective predefined duration and each component providing a predefined acquisition phase; wherein the set of multiple components comprises one or more basic components providing a predefined basic acquisition phase, and at least two additional components providing respective predefined additional acquisition phases, each additional acquisition phase having a respective phase offset with respect to the basic acquisition phase; wherein the durations and the phase offsets of the additional components are arranged such that, in total, the phase offsets of the additional components compensate each other. The electronic device may for example be an image sensor, e.g. an image sensor of an in direct time of flight camera (ToF). An indirect time of flight camera may resolve distance by measuring a phase shift of an emitted light and a back scattered light.

Circuitry may include any electronic elements, semiconductor elements, switches, amplifiers, transistors, processing elements, and the like.

The circuitry may in particular be a driver for ToF unit pixels which provides the in-pixel reference signal (modulated signal) to the signal inputs of one or more unit pixels.

A TOF camera uses light pulses for capturing a scene. Illumination is switched on for a short time (exposure) and the resulting light pulse that illuminates the scene is reflected by the objects in the field of view. TOF cameras work by measuring the phase-delay of e.g. reflected infrared (IR) light. Phase data may be the result of a cross correlation of the reflected signal with a reference signal (typically the illumination signal). Phase data may for example comprise four correlation phases, e.g. phase I (0°), phase Q (90°), phase Ib (180°), and phase Qb (270°), where phases Q/Qb exhibit a phase lag of 90° relative to signals I/Ib, respectively, and may be described as being (relatively) in quadrature; hence, and phases I/Ib are not out of phase, i.e., they are in phase. Each sub-exposure may be associated with one or more specific phases, e.g. phases I, Q, Qb, Ib. A subsequent sub-exposure may have a different phase than the previous sub-exposure. A set of sub-exposures which provides the depth image may for example include four sub-exposures.

The time of flight principle typically uses a limited number of differential mode measurements (acquisition phases) corresponding to different time delays. Each acquisition phase is defined by a predefined phase difference between the in-pixel reference signal and the illumination modulation signal. In this regard, it should be noted that the person skilled in the art will readily appreciate that it is possible to generate acquisition phases (like e.g. the well known acquisition phases 0°, 90°, 180°, 270°, or the like) by keeping the phase of the illumination signal constant and changing the phase of the in-pixel reference signal, or it is possible to generate the acquisition phases by keeping the phase of the in-pixel reference constant and changing the phase of the illumination signal. For instance, four acquisition phase may be used in some embodiments, without limiting the present disclosure in that regard and other embodiments, may use less phase shifts, e.g. two or three, or more phase shifts, e.g. five, six, seven, eight, etc., as is generally known to the skilled person.

A modulation signal may be a signal which is correlated to the signal collected in the unit pixel. Depth measurement accuracy of a iToF system utilizing block wave illumination and mixing signals with acquisition phases (e.g. 0°, 90°, 180°, 270°) may be impacted by cycling error which is caused by higher order odd harmonics of the correlation waveform alias on the fundamental frequency. The harmonic content reduction may be done by adding certain portion of phase offset to the reference signal.

The cyclic error may be reduced by using of three acquisition phases (e.g. 0°, 120°, 240°) which cancels 3^{th} harmonic of the correlation waveform. Still further, the cyclic error may be reduced by using of 5 acquisition phases cancels 3^{th}, 5^{th} and 7^{th} harmonics in the correlation waveform of the correlation waveform. Still further, the cyclic error may be reduced by using of reduced duty cycle of the illumination signal where 33% duty cycle significantly reduces power of 3rd harmonic of the correlation waveform or 40% duty cycle significantly reduces power of 5th harmonic. Still further, the cyclic error may be reduced by using harmonic cancellation by multiple phase offsets in reference illumination signal weighted by sampling reference sine wave. By combining several methods of the correlation waveform harmonic reduction optimized by the minimum total power of all relevant harmonics overall better performance can be achieved. Therefore, a better cancellation of some harmonics of the correlation waveform is possible and the loss of the useful signal is significantly reduced.

Due to the fact that correlation waveform is a result of the convolution of two signals (pixel modulation mix signal, which is typically 50% duty cycle and may not be changed without system performance impact and illumination modulation signal), harmonic reduction methods may be used for one signal only with equal result.

The circuitry may be configured to reduce a cyclic error by optimal harmonic cancellation of the correlation waveform which is achieved by additional phase modulation of the reference signal. An improved cyclic error reduction may be achieved by optimal, though not complete, reduction of all relevant harmonics instead of full cancellation of most significant ones.

The electronic device according to this embodiment has the advantage that the cyclic error of the correlation waveform can be significantly reduced with moderate signal power loss. Still further, the electronic device may be able to optimize the error reduction in of duty cycle distortion. In addition, the electronic device may be easy to implement may be fully digital.

In some embodiments, the durations and the phase offsets of the additional components are arranged such that the sum of each phase offset multiplied with each respective duration is zero.

In some embodiments, the durations and the phase offsets of the additional components are arranged such that an effective acquisition phase during the exposure time corresponds to the predefined basic acquisition phase.

In some embodiments, the circuitry is further configured to generate the in-pixel reference signal with a predefined duty cycle, and to generate the illumination modulation signal with a duty cycle that is reduced compared to the duty cycle of the in-pixel reference signal.

In some embodiments, the circuitry is configured is further to generate emitted light based on the illumination modulation signal. The illumination modulation signal may be transmitted to an illumination unit, which is capable to modulate at least one of a frequency and phase of a light and may include, for example, one or more light emitting diodes, one or more laser elements (e.g. vertical-cavity surface emitting lasers), or the like.

In some embodiments, the circuitry is further configured to sample a correlation waveform based on the in-pixel reference signal and a reflected light signal, wherein the reflected light signal is a scaled and delayed version of the emitted light. The delay may be obtained in the frequency domain by applying a Fourier transformation on correlation wave. The correlation wave may be obtained by performing a cross correlation between the in-pixel reference signal and the signal obtained based on the reflected light signal.

In some embodiments, the exposure time comprises multiple sub-exposures, each sub-exposure comprising a set of multiple components, wherein each respective set of multiple components comprises one or more basic components providing a predefined basic acquisition phase associated with the respective sub-exposure, and at least two additional associated with each sub-exposure.

In some embodiments, the component ratio of the modulation signal is given as:

$$c = \frac{{Σ}_{n = 1}^{M} {a}_{n}}{{Σ}_{n = 1}^{N} {b}_{n}} , \qquad ( Eq . 1 )$$

where c is the component ratio, M is number of basic components, aₙ is the duration of the respective basic components, N is number of additional components, bₙ is the duration of the respective additional components, wherein the component ratio is from 0.2 to 2.

In some embodiments, the duty cycle of the illumination modulation signal is in range of 25 to 50%.

In some embodiments, the duty cycle of the illumination modulation signal is in range of 29 to 36%.

In some embodiments, the phase offset of the second additional components are in a range from 9° to 50°. In actual system it may be not possible or too difficult to achieve any arbitrary phase offset. Phase offsets±36°, ±30°, ±22.5° or ±18° may be relatively easy to achieve. In some system implementation these phase offsets may be hard linked to achievable duty cycle being 35%, 33.3%, 31.25% and 30%. Though it may not perfect match to the most optimal signal parameters (component ratio may be not optimal), the resulting cyclic error is still better than the cyclic error achieved by conventional methods with still lower power loss.

In some embodiments, the additional components comprise a first additional component with a phase shifted from the basic acquisition phase with a positive phase offset, and a second component with a phase shifted from the phase of the first component with a negative phase offset.

In some embodiments, the illumination modulation signal is phase modulated. The illumination modulation signal may be extra frequency or phase modulated with proper selection of secondary modulation frequency and maximum phase deviation. This can be expressed as an extra phase modulation of the illumination modulation signal (respectively, the resulting illumination signal/emitted light).

In some embodiments, the phase modulation frequency is smaller than the modulation frequency of the illumination modulation signal. The illumination modulation signal structure may be also a particular example of phase modulation.

In some embodiments, the sub-exposure comprises a first basic component with a phase that corresponds to the basic acquisition phase, a second basic component with a phase that corresponds to the basic acquisition phase, a first additional component with a phase shifted from the phase of the first component with a negative phase offset, and a second additional component with a phase shifted from the basic acquisition phase with a positive phase offset. The structure of the sub-exposure with four components may be irrelevant to the sequence of different phase portions due to the integration principal of the phase acquisition. However, in order to achieve high robustness to the external impairments (for example ambient light flickering or target motion), it may be also possible to spread additional phase offset illumination pulses along the integration time. In this case, each portion duration is defined by number of illumination light pulses, where each pulse is the same in width and amplitude. For example, component ratio c=0.8 (may be optimal for duty cycle 35%) can be achieved with 5 illumination pulses for the portions b with phase offset −Δϕ, another 5 illumination pulses with phase offset +Δϕ and 8 pulses of the portion a with phase ϕ₀; overall 18 pulses long sequence is repeated over the integration time.

The embodiments also disclose a time of flight camera comprising the circuitry according to the embodiments described above. The time of flight (ToF) camera is to be understood functionally, and, for instance, it can be integrated in another electronic device, such as a computer, smartphone, mobile phone, laptop, digital (still/video) camera, etc. In other embodiments, the ToF camera may also be a standalone device including, for example, a housing, a user interface for operating the ToF camera, and the like.

The embodiments also disclose a method comprising generating, during an exposure time, an in-pixel reference signal, wherein the exposure time comprises one or more sub-exposures, each sub-exposure comprising a set of multiple components, each component having a respective predefined duration and each component providing a predefined acquisition phase; wherein the set of multiple components comprises one or more basic components providing a predefined basic acquisition phase, and at least two additional components providing respective predefined additional acquisition phases, each additional acquisition phase having a respective phase offset with respect to the basic acquisition phase; wherein the durations and the phase offsets of the additional components are arranged such that, in total, the phase offsets of the additional components compensate each other.

FIG. 1 illustrates schematically the basic operational principle of a time-of-flight (ToF) camera. The ToF camera 3 includes a clock generator 5, an amplifier 14, a dedicated illumination unit 18, a lens 2, an imaging sensor 1, a first mixer 20, a second mixer 21. The ToF camera 3 captures 3D images of a scene 15 by analyzing the time-of-flight of light from a dedicated illumination unit 18 to an object. The dedicated illumination unit 18 obtains a modulation signal, for example a square wave signal with a predetermined frequency, which is generated by the clock generator 5. The scene 15 is actively illuminated with an emitted light 16 at a predetermined wavelength using the dedicated illumination unit 18. The emitted light 16 is reflected back from objects within the scene 15. A lens 2 collects the reflected light 17 and forms an image of the objects onto the imaging sensor 1 of the ToF camera 3. Depending on the distance of objects from the camera, a delay is experienced between the emission of the emitted light 16, e.g. the so-called light pulses, and the reception at the camera of those reflected light pulses 17. Distances between reflecting objects and the camera may be determined as function of the time delay observed and the speed of light constant value.

Indirect time-of-flight (iToF) cameras determine this time delay between the emitted light 16 and the reflected light 17 for obtaining depth measurements by sampling in each iToF camera pixel with mixers 20, 21 of the imaging sensor 1 a respective correlation waveform 22, 23, e.g. between modulation signals (here 0° and 90°) generated by the timing generator 5 and which act as reference signals, and the reflected light 17 that is stored in the iToF camera pixel of the imaging sensor 1. iToF cameras typically measure an approximation of a first harmonic of the correlation measurement. This approximation typically uses a limited number of differential mode measurements (acquisition phases) corresponding to different time delays. This first harmonic estimate is also referred to as IQ measurement (with I and Q the real resp. imaginary part of the first harmonic estimate).

Consider an iToF camera pixel imaging an object at a distance D. A (differential) iToF pixel measurement v(τ_{E}, τ_{D}) is a variable whose expected value is given by

μ(τ_{E},τ_{D})=E(v(τ_{E},τ_{D}))=∫₀^{T}^{_{I}}m(t)ϕ_{R}(t,τ_{E},τ_{D})dt (Eq. 2)

where, t is the time variable, T_{I} is the exposure time (integration time), m(t) is the in-pixel reference signal (“pixel modulation mix signals”) which corresponds to the modulation signal or a phase shifted version of the modulation signal (generated by the clock generator 5 in FIG. 1), and Φ_{R} (t, τ_{E}, τ_{D}) is the pixel irradiance signal which represents the reflected light (17 in FIG. 1) captured by the pixel. τ_{E} represents a time variable indicative of the time delay between the in-pixel reference signal (modulation signal) and the emitted light (16 in FIG. 1), and τ_{D} is a time variable representing the time that it is required for the light to travel from the ToF camera (3 in FIG. 1) to the object (15 in FIG. 1) and back. Neglecting the parallax effect, the time variable τ_{D} is given by:

$${τ}_{D} = \frac{2 D}{c} \qquad ( Eq . 3 )$$

where D is the distance between the ToF camera and the object, and c is the speed of light.

The reflected light signal Φ_{R}(t, τ_{E}, τ_{D}) is a scaled and delayed version of the emitted light Φ_{E}(t−τ_{E}). The pixel irradiance signal Φ_{R}(t, τ_{E}, τ_{D}) is given by:

Φ_{R}(t,τ_{E},τ_{D})=Φ(τ_{D})×Φ_{E}(t−τ_{E}−τ_{D}) (Eq. 4)

where Φ(τ_{D}) is a real value scaling factor that depends on the distance D between the ToF camera and the object, and Φ_{E}(t−τ_{E}−τ_{D}) is the emitted light Φ_{E}(t−τ_{E}) (16 in FIG. 1) additionally delayed with the time variable τ_{D}.

In the context of iToF, both m(t) and ϕ_{E}(t) are periodical signals with period T_{M}=f_{M}⁻¹ (f_{M} being the fundamental frequency or modulation frequency generated by the modulation clock (5 in FIG. 1).

As T_{I}»T_{M}, the expected differential signal μ(τ_{E}, τ_{D}) is also a periodical function with respect to the electronic delay τ_{E} between in-pixel reference signal m(t) and optical emission Φ_{E}(t−τ_{E}) with the same fundamental frequency f_{M}.

Writing μ(τ_{E}, τ_{D}) in terms of its Fourier Coefficients Mₖ yields

$$μ ( {τ}_{E} , {τ}_{D} ) = Φ ( {τ}_{D} ) {\sum }_{k = - ∞}^{∞} ( {M}_{k} {e}^{j 2 {kf}_{M} {τ}_{D}} ) {e}^{j 2 {kf}_{M} {τ}_{E}} \qquad ( Eq . 5 )$$

Note that due to the distance-dependent scaling of the light (factor Φ(τ_{D})), the expected differential signal μ(τ_{E}, τ_{D}) is not periodical with respect to the time-of-flight τ_{D}.

From the above it is clear that the time-of-flight, and hence depth, can be estimated from the first harmonic H₁(τ_{D}) of μ(τ_{E}, τ_{D}):

$${H}_{1 , μ} ( {τ}_{D} ) = \int μ ( {τ}_{E} , {τ}_{D} ) {e}^{- j 2 {f}_{m} {τ}_{E}} d {τ}_{E} ∝ Φ ( {τ}_{D} ) {M}_{1} {e}^{j 2 {f}_{M} {τ}_{D}} \qquad ( Eq . 6 )$$

From the first harmonic H_{1,μ}(τ_{D}) the phase angle θ_{1,μ}(τ_{D}) is obtained as

θ_{1,μ}(τ_{D})=∠H_{1,μ}(τ_{D})=2πf_{M}τ_{D}+ψ_{M}_{₁} (Eq. 7)

with

ψ_{M}_{₁}∠M₁ (Eq. 8)

Here, ∠ denotes the phase of a complex number z=re^{iϕ}

∠z=∠(re^{iϕ})=ϕ (Eq. 9)

In practice, it is not feasible to evaluate H_{1,μ}(τ_{D}) due to the presence of noise and due to the number of transmit delays.

Concerning the presence of noise, H_{1,μ}(τ_{D}) is formulated in terms of the expected value μ(τ_{E}, τ_{D}) of differential mode measurements v(τ_{E}, τ_{D}). Estimating this expected value from measurements may be performed by multiple repeated acquisitions (of static scene) to average out noise.

Concerning the number of transmit delays, H_{1,μ}(τ_{D}) is given as an integral over all possible transmit delays τ_{E}. Approximating this integral may require a high number of transmit delays.

Due to these reasons iToF systems measure an approximation of this first harmonic H_{1,μ}(τ_{D}). This approximation typically uses a limited number of S differential mode measurements (acquisition phases) v(τ_{E,n}, τ_{D}) (n=0, . . . , S−1) corresponding to S electronic transmit delays τ_{E,n}. A vectorized representation of this set of transmit delays is:

t_{E}=[τ_{E,0} . . . τ_{E,S-1}]^{T} (Eq. 10)

The approximation of the first harmonic H_{1,μ}(τ_{D}) is typically obtained by an S-point EDFT (Extended Discrete Fourier Transform), according to

$${H}_{1 , v} ( {τ}_{D} ; {t}_{E} ) = {\sum }_{n = 0}^{S - 1} v ( {τ}_{E , n} , {τ}_{D} ) {e}^{- j 2 \frac{hn}{S}} \qquad ( Eq . 11 )$$

with h being the S-point EDFT bin considered. In standard iToF, h=1. However, depending on the transmit delays selected, different values of h could be more appropriate. For simplicity and without loss of generality, we will assume h=1 in the remainder of this disclosure:

$${H}_{1 , ν} ( {τ}_{D} ; {t}_{E} ) = {\sum }_{n = 0}^{S - 1} ν ( {τ}_{E , n} , {τ}_{D} ) {e}^{- j 2 \frac{n}{S}} \qquad ( Eq . 12 )$$

This first harmonic estimate H_{1,v}(τ_{D}; t_{E}) is also referred to as IQ measurement (with I and Q the real resp. imaginary part of the first harmonic estimate). In order to stay close to iToF nomenclature, in the following H_{1,v}(τ_{D}; t_{E}) is denoted as “IQ measurement”. However, it is important to remember that an IQ measurement is an estimate of the first harmonic H_{1,μ}(τ_{D}) of the expected differential measurement (as function of transmit delay).

Due to the statistical nature of the differential mode measurements v(τ_{E,n}, τ_{D}), the IQ measurement H_{1,v}(τ_{D}; t_{E}) is a random variable with the following expected value

$$E ( {H}_{1 , v} ( {τ}_{D} ; {t}_{E} ) ) ≡ {H}_{1 , μ} ( {τ}_{D} ; {t}_{E} ) = {\sum }_{n = 0}^{S - 1} μ ( {τ}_{E , n} , {τ}_{D} ) {e}^{- j 2 π \frac{n}{S}} \qquad ( Eq . 13 )$$

This expected value is here referred to as expected IQ measurement. In general, the IQ measurement H_{1,v}(τ_{D}; t_{E}) is a biased estimator of the intended first harmonic H_{1,μ}(τ_{D}), meaning that the expected IQ measurement H_{1,μ}(τ_{D}; t_{E}) is only an approximation of the intended harmonic H_{1,μ(}τ_{D}) and thus not equal to the intended harmonic:

H_{1,μ}(τ_{D};t_{E})≠H_{1,μ}(τ_{D}) (Eq. 14)

This is because H_{1,μ}(τ_{D}; t_{E}) relies on a small set of S transmit delays and a measurement of the exact harmonic H_{1,μ}(τ_{D}) requires an infinite amount of transmit delays (integral).

### Cyclic Error Function

As an extension of this, the expected IQ measurement's phase θ_{1,μ}(τ_{D}; t_{E})∠H_{1,μ}(τ_{D}; t_{E}) also differs from the intended harmonic's phase θ_{1,μ}(τ_{D})∠H_{1,μ}(τ_{D}):

θ_{1,μ}(τ_{D};t_{E})≠θ_{1,μ}(τ_{D}) (Eq. 15)

In general, the phase θ_{1,μ}(τ_{D}; t_{E}) is related to θ_{1,μ}(τ_{D}) through a cyclic error function f_{CE}(θ_{1,μ}(τ_{D}); x), according to:

θ_{1,μ}(τ_{D};t_{E})=θ_{1,μ}(τ_{D})+f_{CE}(θ_{1,μ}(τ_{D});x) (Eq. 16)

This cyclic error function which describes the cyclic phase error (in the following “cyclic error” or “phase error”) depends on the properties of the expected differential measurement signal μ(τ_{E}, τ_{D}) and of the set t_{E} of transmit delays applied.

Cyclic error reduction intends to reduce the cyclic error f_{CE}(θ_{1,μ}(τ_{D}); x).

### Cyclic Error Reduction

The cyclic error can be reduced in several ways:

For example, the use of three acquisition phases (0°, 120°, 240°) cancels 3^{rd} harmonic H_{3,μ}(τ_{D}) of the correlation waveform (but not the cyclic error due to the 5^{th} and 7^{th} harmonics). Still further, the use of five acquisition phases cancels 3^{rd} harmonic H_{3,μ}(τ_{D}), 5^{th} harmonic H_{5,μ}(τ_{D}) and 7^{th} harmonic H_{7,μ}(τ_{D}) in the correlation waveform of the correlation waveform. The use of five acquisition phases typically causes ˜10.5% losses in signal power, and increases the amount of the data to be transferred and processed by 25% and needs more complex data processing.

Still further, the use of reduced duty cycle of the illumination waveform where 33% duty cycle significantly reduces the power of the 3^{th} harmonic H_{3,μ}(τ_{D}) of the correlation waveform (but does not solve cyclic error due to the 5^{th} and 7^{th} harmonics) or 40% duty cycle significantly reduces the power of the 5^{th} harmonic H_{5,μ}(τ_{D}) (but does not solve cyclic error due to 3rd and 7th harmonics in case of 40% duty cycle). The requirement for tight duty cycle control may be avoided by use of optimal of phase offset value and duration of the compensation components with this offset.

Still further, harmonic cancellation by multiple phase offsets in reference illumination signal weighted by sampling reference sine wave. This harmonic cancellation by multiple phase offsets in the reference illumination signal weighted by sampling reference sine wave typically leads to a significant loss of signal power (˜13% for 3^{rd} and 5^{th} harmonics cancellation or about ˜20% for 3-9 harmonics cancellation) and the remaining 7^{th} and 9^{th} harmonics produce still remarkable cyclic error (in case of 3rd and 5th harmonics cancellation).

Still further, the cyclic error can be reduced by combining the above mention methods to the properties of the illumination waveform as described in the following. By combining several methods of the correlation waveform harmonic reduction optimized by the minimum total power of all relevant harmonics overall better performance can be achieved. By combining different methods for cyclic error reduction, a better cancellation of some harmonics of the correlation waveform can be achieved, or leads to less loss of the useful signal. Combining different methods for cyclic error reduction makes these methods less sensitive to the accuracy of controlled properties of the signals (for example duty cycle of illumination reference signal).

Due to the fact that correlation waveform is a result of the convolution of two signals (see Eq. 2 above), namely the in-pixel reference signal m(t), which is typically 50% duty cycle and which can be changed only by changing the system implementation, and pixel irradiance signal ϕ_{R}(t, τ_{E}, τ_{D})), harmonic reduction methods can be used for one signal only with equal result.

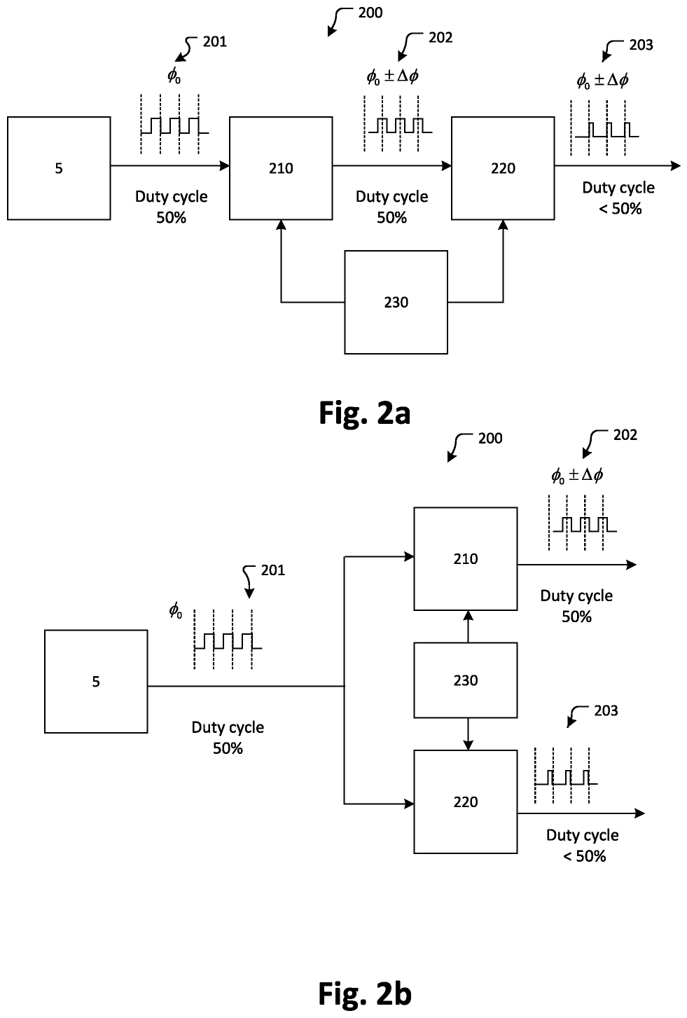

Accordingly, in the following embodiments, a reduction of the duty cycle (see FIG. 2 below) of the illumination waveform (<50%) and additional two phases with phase offset +Δϕ to the in-pixel reference signal m(t) (“acquisition phase”) (see FIG. 2 below) is applied.

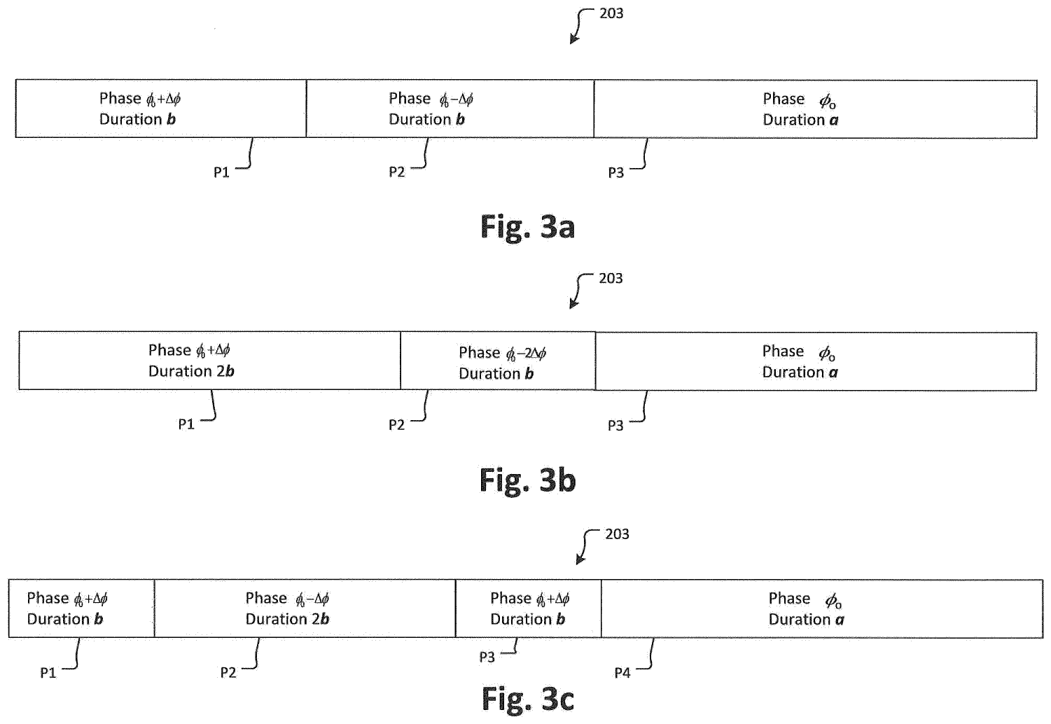

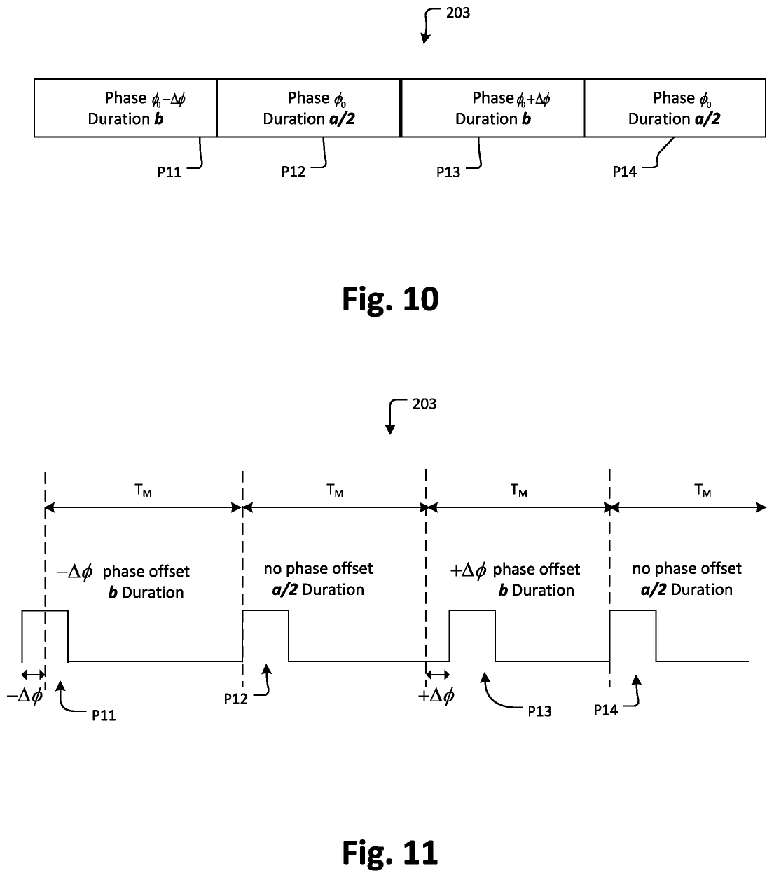

FIG. 2a illustrates as an embodiment, a modulation circuit for shifting a phase and changing a duty cycle of the modulation signal. A phase shift circuit 210 of the modulation circuit 200 retrieves a modulation signal 201 with a phase of ϕ₀ from a clock generator 5 (clock generator 5 of FIG. 1) and outputs a phase shifted modulation signal 202 with a shifted phase ϕ₀±Δϕ. The phase offset +Δϕ introduced by phase shift circuit 210 is based on input parameters provided by controller 230. Here, ± denotes that the phase shift Δϕ may be positive or negative and Δϕ denotes an arbitrary positive phase angle, which may for example be ±36°, ±30°, ±22.5° or ±18°, or the like. The phase shifted modulation signal 202 is transmitted to a Duty-cycle-modifier 220. The Duty-cycle-modifier 220 outputs illumination modulation signal 203 with a reduced duty cycle. The term duty cycle describes the ratio of duty cycle to regular interval or period; a low duty cycle corresponds to a low power because the power is switched off most of the time. The duty cycle is expressed as a percentage where 100% is fully on. When a digital signal is on half the time and the other half is off, the digital signal has a duty cycle of 50% and resembles a “square wave”. If a digital signal spends more time on than off, it has a duty cycle of >50%. If a digital signal spends more time off than on, it has a duty cycle of <50%. The reduced duty cycle introduced by Duty-cycle-modifier 220 is based on input parameters provided by controller 230 and may be for example 35%, 33.3%, 31.25% or 30%, or the like. The controller 230 controls the phase shift circuit 210 and the Duty-cycle-modifier 220. The controller 230 provides input parameters for determining the phase offset Δϕ to the phase shift circuit 210 and input parameters for determining the duty cycle to the Duty-cycle-modifier 220. The input parameters provided as control information by the controller 230 define the structure of the illumination modulation signal 203. Embodiments which apply the illumination modulation circuit 200 of FIG. 2 to provide a structured illumination modulation signal are described in more detail in FIGS. 3a, 3b, 3c and 10. Delay locked loop (DLL) may be considered as phase shift circuit 210 and duty cycle modifier 220. The DLL may comprise a variable delay chain, which is formed by a chain of individual elementary delay links with a fixed delay time. The instantaneous delay of the entire chain depends on the phase position between input and output signal and is set dynamically during operation via a control signal.

The illumination modulation signal 203 produced by the illumination modulation circuit 200 of FIG. 2a is provided to an illumination unit (18 in FIG. 1) to produce emitted light Φ_{E}(t−τ_{E}) (16 in FIG. 1) which is reflected back from objects within a scene (15 in FIG. 1) and which is captured by pixels of the imaging sensor (1 in FIG. 1) of the ToF camera as pixel irradiance signal Φ_{R}(t,τ_{E},τ_{D}) (see Eq. 4 above).

FIG. 2b illustrates as another embodiment, a modulation circuit for shifting a phase and changing a duty cycle of the modulation signal. A phase shift circuit 210 of the modulation circuit 200 retrieves a modulation signal 201 with a phase of ϕ₀ from a clock generator 5 (clock generator 5 of FIG. 1) and outputs a phase shifted modulation signal 202 with a shifted phase ϕ₀±Δϕ. The phase offset +Δϕ introduced by phase shift circuit 210 is based on input parameters provided by controller 230. Here, ± denotes that the phase shift Δϕ may be positive or negative and Δϕ denotes an arbitrary positive phase angle, which may for example be ±36°, ±30°, ±22.5° or ±18°, or the like. The phase shifted modulation signal 202 is transmitted to a mixer (20, 21 of FIG. 1), which act as an in-pixel reference signal. A Duty-cycle-modifier 220 of the modulation circuit 200 retrieves a modulation signal 201 with a phase of ϕ₀ and a predetermined duty cycle. The term duty cycle describes the ratio of duty cycle to regular interval or period; a low duty cycle corresponds to a low power because the power is switched off most of the time. The Duty-cycle-modifier 220 outputs modulation signal 203 with a reduced duty cycle. The reduced duty cycle introduced by Duty-cycle-modifier 220 is based on input parameters provided by controller 230 and may be for example 35%, 33.3%, 31.25% or 30%, or the like. The illumination modulation signal 203 produced by the Duty-cycle-modifier 220 of FIG. 2 is provided to an illumination unit (18 in FIG. 1) to produce emitted light Φ_{E}(t−τ_{E}) (16 in FIG. 1) which is reflected back from objects within a scene (15 in FIG. 1) and which is captured by pixels of the imaging sensor (1 in FIG. 1) of the ToF camera as pixel irradiance signal Φ_{R}(t, τ_{E}, τ_{D}) (see Eq. 4 above). The controller 230 controls the phase shift circuit 210 and the Duty-cycle-modifier 220. The controller 230 provides input parameters for determining the phase offset Δϕ to the phase shift circuit 210 and input parameters for determining the duty cycle to the Duty-cycle-modifier 220. The input parameters provided as control information by the controller 230 define the structure of the modulation signal 203. Embodiments which apply the modulation circuit 200 of FIG. 2 to provide a structured modulation signal are described in more detail in FIGS. 3a, 3b, 3c and 10. Delay locked loop (DLL) may be considered as phase shift circuit 210 and duty cycle modifier 220. The DLL may comprise a variable delay chain, which is formed by a chain of individual elementary delay links with a fixed delay time. The instantaneous delay of the entire chain depends on the phase position between input and output signal and is set dynamically during operation via a control signal.

As describe with regard to equations (1) and (9) above, an iToF system according to the present embodiments measures a limited number of S differential mode measurements (acquisition phases) v(τ_{E,n}, τ_{D}) (n=0, . . . , S−1) corresponding to S electronic transmit delays τ_{E,n} based on a pixel irradiance signal Φ_{R}(t, τ_{E}, τ_{D}) which represents the reflected light (17 in FIG. 1) captured by the pixel. τ_{E} represents a time variable indicative of the time delay between the in-pixel reference signal (modulation signal) and the emitted light (16 in FIG. 1), and τ_{D} is a time variable representing the time that it is required for the light to travel from the ToF camera (3 in FIG. 1) to the object (15 in FIG. 1) and back.

FIG. 3a illustrates schematically as an embodiment, a structure of the illumination modulation signal in a sub-exposure. A sub-exposure may be associated with one or more predefined acquisition phase. A subsequent sub-exposure may have a different phase than the previous sub-exposure. A set of sub-exposures which provides the depth image may for example include four sub-exposures. The illumination modulation signal 203 comprises a basic sub-exposure component (illumination waveform component) P3, a first additional component (illumination waveform component) P1 and a second additional component (illumination waveform component) P2. Each sub-exposure component P1, P2, P3 is the sequence of the illumination light pulses with a repetition rate proportional to a selected modulation frequency (f_{M}) and specific duty cycle, e.g. 35%, 33.3%, 31.25% or 30%. The basic component P3 has a duration of a and a phase of ϕ₀. This phase ϕ₀ of the basic component P3 of the illumination modulation signal 203 corresponds to the to one of the acquisition phases S (e.g. 0°, 90°, 180°, 270°) or it is constant in case acquisition phases are applied in the pixel modulation mix signals. Due to the fact that correlation waveform is a result of the convolution of two signals (see Eq. 2) acquisition phase S is applied to only one signal. In case S applied to mix signal, phase ϕ₀ of signal is always zero, i.e. constant for all acquisition phases. The additional components P1 and P2 each have a duration of b and phase offsets +Δϕ and −Δϕ with respect to phase ϕ₀, i.e. the first additional component P1 has a phase of ϕ₀+Δϕ and the second additional component P2 has a phase of ϕ₀−Δϕ. The phase offset Δϕ may be for example ±36°, ±30°, ±22.5° or +18°.

Thus, for the S acquisition phases, the transmit delays t_{E} between the in-pixel reference signal (modulation signal) and the pixel irradiance signal Φ_{R}(t, τ_{E}, τ_{D}) based on the illumination modulation signal 203 as described in FIG. 3a are:

t_{E}=[τ_{E,0,ϕ}_{₀},τ_{E,0,ϕ}_{₀}_{+Δϕ},τ_{E,0,ϕ}_{₀}_{-Δϕ} . . . τ_{E,S-1,ϕ}_{₀},τ_{E,S-1,ϕ}_{₀}_{+Δϕ},τ_{E,S-1,ϕ}_{₀}_{-Δϕ}]^{T} (Eq. 17)

That is, in the proposed structure of the illumination signal as presented in FIG. 3, the illumination signal for any acquisition phase (e.g. four acquisition phases are considered) contains the three components.

The component ratio of the structure of the illumination modulation signal 203 shown in FIG. 3a is given as:

$$c = \frac{a}{2 b} , \qquad ( Eq . 18 )$$

where c is the component ratio, a is the duration of basic component P3 with no phase offset and b is the duration of the additional components P1 and P2 with phase offset +Δϕ.

The duration a expressed in terms of is the component ratio C and the total integration time Tᵢₙₜ is given as:

$$a = {T}_{i n t} \times \frac{c}{c + 1} , \qquad ( Eq . 19 )$$

where Tᵢₙₜ is the total integration time equal to the duration of a+2b. The duration b expressed in terms of is the component ratio c and the total integration time Tᵢₙₜ is given as:

$$b = {T}_{i n t} \times \frac{1}{2 ( c + 1 )} . \qquad ( Eq . 20 )$$

The additional components (compensation component) P1 and P2 are used for harmonic content reduction.

FIG. 3b illustrates schematically as another embodiment, a structure of the illumination modulation signal in a sub-exposure. A subsequent sub-exposure may have a different phase than the previous sub-exposure. A set of sub-exposures which provides the depth image may for example include four sub-exposures. The illumination modulation signal 203 comprises a basic sub-exposure component (illumination waveform component) P3, a first additional component (illumination waveform component) P1 and a second additional component (illumination waveform component) P2. Each component may be the sequence of the illumination light pulses with the repetition rate proportional to the selected modulation frequency f_{M} and specific duty cycle, e.g. 35%, 33.3%, 31.25% or 30%. The basic component P3 has a duration of a and a phase of ϕ₀. This phase ϕ₀ of the illumination waveform component P3 of the modulation signal 203 corresponds to the to one of the acquisition phases S (e.g. 0°, 90°, 180°, 270°) or it is constant in case acquisition phases are applied in the pixel modulation mix signals. Due to the fact that correlation waveform is a result of the convolution of two signals (see Eq. 2) acquisition phase S is applied to only one signal. In case S applied to mix signal, phase ϕ₀ of signal is always zero, i.e. constant for all acquisition phases. The first additional component P1 have a duration of 2b and phase offsets +Δϕ and the second additional component P2 have a duration of b and phase offsets −2Δϕ. The phase offset Δϕ may be for example ±36°, ±30°, ±22.5° or ±18°. Thus, for the S acquisition phases, the transmit delays t_{E} between the in-pixel reference signal (modulation signal) and the pixel irradiance signal Φ_{R}(t, τ_{E}, τ_{D}) based on the illumination modulation signal 203 as described in FIG. 3b are:

t_{E}=[τ_{E,0,ϕ}_{₀},τ_{E,0,ϕ}_{₀}_{+Δϕ},τ_{E,0,ϕ}_{₀}_{-2Δϕ} . . . τ_{E,S-1,ϕ}_{₀},τ_{E,S-1,ϕ}_{₀}_{+Δϕ},τ_{E,S-1,ϕ}_{₀}_{-2Δϕ}]^{T} (Eq. 21)

That is, in the proposed structure of the signal as presented in FIG. 3b, the signal for any acquisition phase (e.g. four acquisition phases are considered) contains the three components, where the mean phase of the three components is the acquisition phase ϕ₀. The illumination waveform component ratio of the structure of the illumination modulation signal 203 shown in

FIG. 3b is given as:

$$c = \frac{a}{b + 2 b} , \qquad ( Eq . 22 )$$

where c is the component ratio, a is the duration of the basic component P3 with no phase offset, 2b is the duration of the first additional component P1 with phase offset ±Δϕ and b is the duration of the second additional component P2 with phase offset −2Δϕ. The additional components (compensation component) P1 and P2 are used for harmonic content reduction.

FIG. 3c illustrates schematically as another embodiment, a structure of the illumination modulation signal in a sub-exposure. A subsequent sub-exposure may have a different phase than the previous sub-exposure. A set of sub-exposures which provides the depth image may for example include four sub-exposures. The illumination modulation signal 203 comprises a basic sub-exposure component (illumination waveform component) P4, a first additional component (illumination waveform component) P1, a second additional component (illumination waveform component) P2 and a third additional component (illumination waveform component) P3. Each sub-exposure component P1, P2, P3 is the sequence of the illumination light pulses with a repetition rate proportional to a selected modulation frequency (f_{M}) and specific duty cycle, e.g. 35%, 33.3%, 31.25% or 30%. The basic component P4 has a duration of a and a phase of ϕ₀. This phase ϕ₀ of the illumination waveform component P4 of the illumination modulation signal 203 corresponds to the to one of the acquisition phases S (e.g. 0°, 90°, 180°, 270°) or it is constant in case acquisition phases are applied in the pixel reference signals. Due to the fact that correlation waveform is a result of the convolution of two signals (see Eq. 2) acquisition phase S is applied to only one signal. In case S applied to mix signal, phase ϕ₀ of signal is always zero, i.e. constant for all acquisition phases. The first additional component P1 have a duration of b and phase offsets +Δϕ, the second additional component P2 have a duration of 2b and phase offsets −Δϕ and the third additional component P3 have a duration of b and phase offsets +Δϕ. The phase offset Δϕ may be for example ±36°, ±30°, ±22.5° or ±18°. Thus, for the S acquisition phases, the transmit delays t_{E} between the in-pixel reference signal and the pixel irradiance signal Φ_{R}(t, τ_{E}, τ_{D}) based on the illumination modulation signal 203 as described in FIG. 3c are:

t_{E}=[τ_{E,0,ϕ}_{₀},τ_{E,0,ϕ}_{₀}_{+Δϕ},τ_{E,0,ϕ}_{₀}_{-Δϕ},τ_{E,0,ϕ}_{₀}_{Δϕ} . . . τ_{E,S-1,ϕ}_{₀},τ_{E,S-1,ϕ}_{₀}_{+Δϕ},τ_{E,S-1,ϕ}_{₀}_{-Δϕ},τ_{E,S-1,ϕ}_{₀}_{+Δϕ]}^{T} (Eq. 23)

That is, in the proposed structure of the signal as presented in FIG. 3c, the signal for any acquisition phase (e.g. four acquisition phases are considered) contains the four components, where the mean phase of the three components is the acquisition phase ϕ₀.

The illumination waveform component ratio of the structure of the modulation signal 203 shown in FIG. 3c is given as:

$$c = \frac{a}{b + b + 2 b} , \qquad ( Eq . 24 )$$

where c is the component ratio, a is the duration of the illumination waveform component P3 with no phase offset, b is the duration of the illumination waveform component P1 with phase offset +Δϕ, b is the duration of the illumination waveform component P2 with phase offset ±Δϕ and 2b is the duration of the illumination waveform component P3 with phase offset −Δϕ. The additional components (compensation component) P1, P2 and P3 are used for harmonic content reduction.

In the embodiments of FIGS. 3a, 3b, 3c, the phase offsets of the additional components are multiples of a predefined phase offset ±Δϕ. However, in alternative embodiments, the phase offsets of the additional components may be arbitrarily chosen in a way such that they compensate each other. They do not necessarily have to be multiples of a predefined phase offset.

In the embodiments of FIGS. 3a, 3b, 3c, each sub-exposure comprises either two or three additional phases. However, the skilled person will readily appreciate that, in alternative embodiments, more than more the three additional components. That is, the modulation signal may comprises N additional components with phase offset Δϕₙ and a respective duration bₙ. The phase offsets compensate each other in total if, for example, the sum of each phase offset Δϕₙ multiplied with each respective duration bₙ is zero:

Σₙ₌₁^{N}Δϕₙ×bₙ=0 (Eq. 25)

The illumination waveform component ratio of the structure of the modulation signal is given as:

$$c = \frac{a}{{Σ}_{n = 1}^{N} {b}_{n}} , \qquad ( Eq . 26 )$$

where c is the component ratio, a is the durations of the illumination waveform component with no phase offset and bₙ are the durations of the illumination waveform component with phase offset Δϕₙ. Still further, the embodiments of FIGS. 3a, 3b, 3c disclose a structured illumination modulation signal in which, during a sub-exposure, the illumination modulation signal comprises multiple components with different phase offsets. However, the skilled person will readily appreciate that, in alternative embodiments, the in-pixel reference signal could be structured as described with regard to the embodiments of FIGS. 3a, 3b, and 3c.

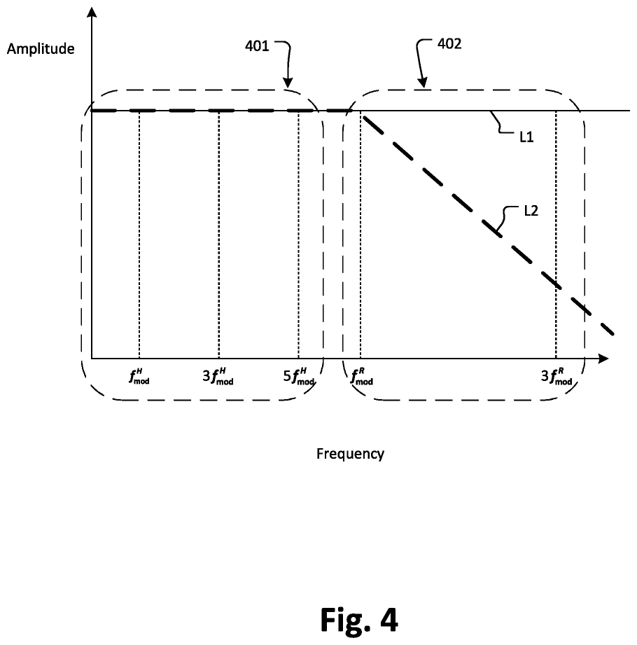

FIG. 4 graphically compares the frequency response of an ideal system, a real system, a high bandwidth system and a reduced bandwidth system. Harmonic content of the correlation waveform depends on the system bandwidth, which is generally limited by pixel and illumination circuit constrains and related to the modulation frequency. FIG. 4 shows on the abscissa a frequency and on the ordinate the amplitude of the correlation waveform. The solid line L1 represents the frequency response of an ideal system. The dashed line L2 represents the frequency response of a real system. The high bandwidth system 401 corresponds to a system where higher order harmonics are not attenuated and in which the modulation frequency is lower than the real system bandwidth L2 and harmonic content is similar to ideal block waves. The reduced bandwidth system 402 corresponds to a system where higher order harmonics are attenuated and in which the modulation frequency is higher than the real system bandwidth L2 and harmonic content is similar to ideal block waves. The modulation frequency f_{mod}^{H} may be for example 20 MHz. The real system may have for example 100 MHz frequency response bandwidth, the modulation frequency f_{mod}^{H} of the high bandwidth system 401 may be for example 20 MHz and the modulation frequency f_{mod}^{R} of the reduced bandwidth system 402 may be for example 100 MHz. Higher order harmonics may be attenuated similar to low pass filter behavior.

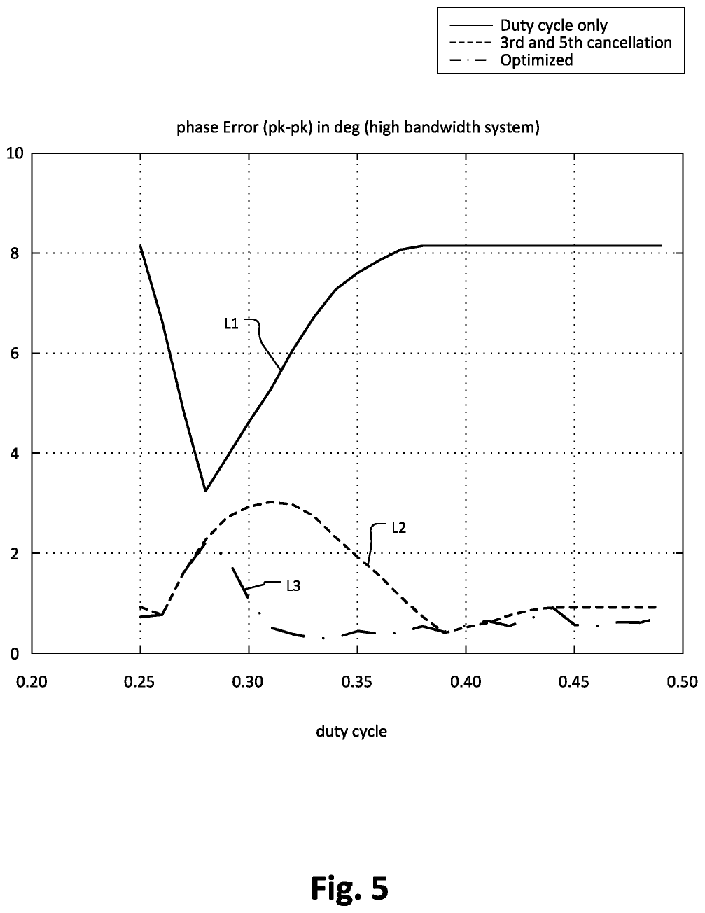

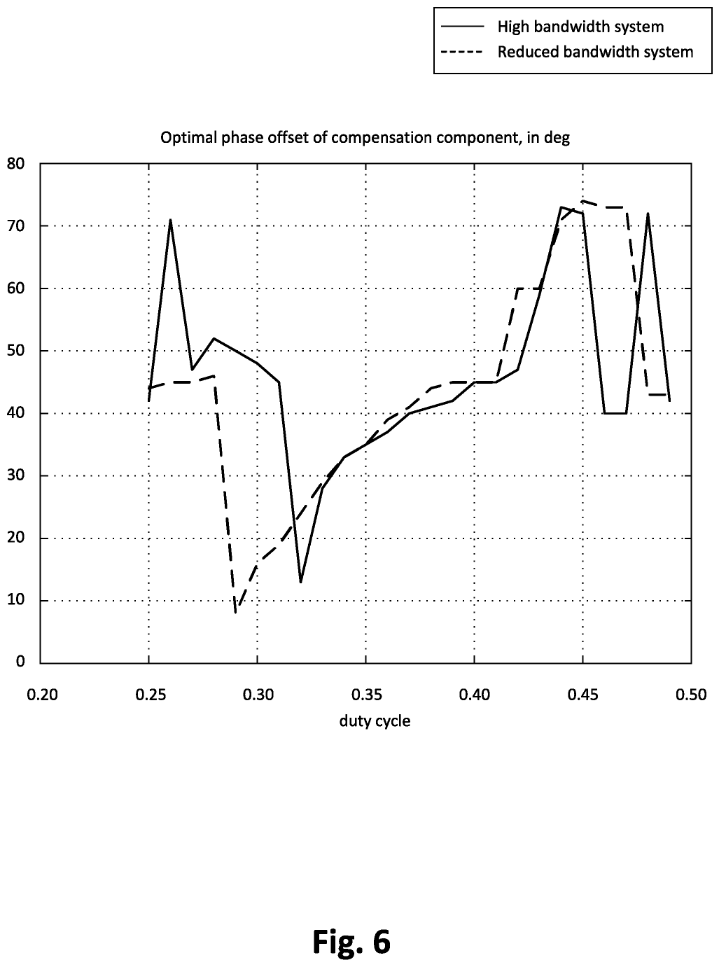

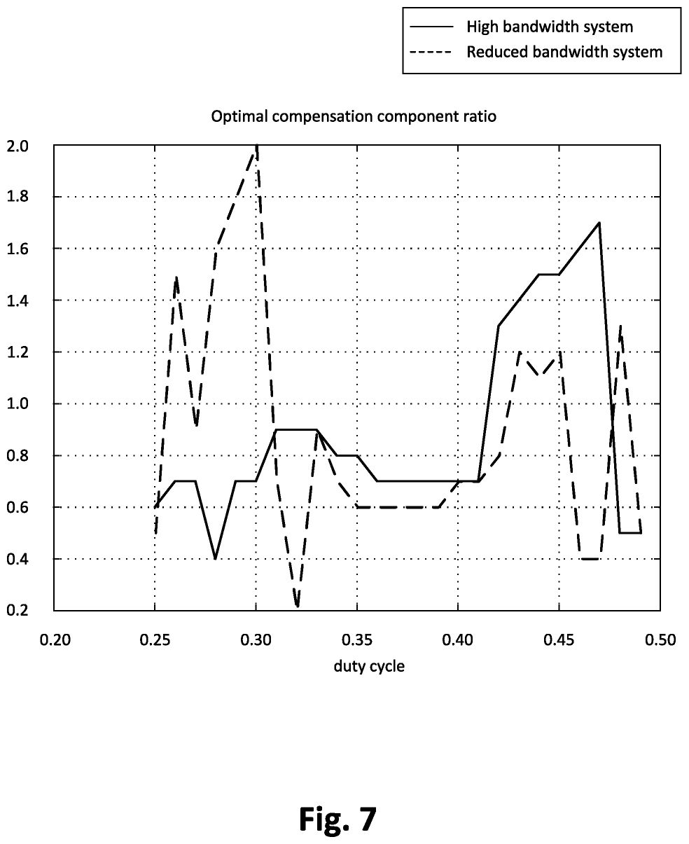

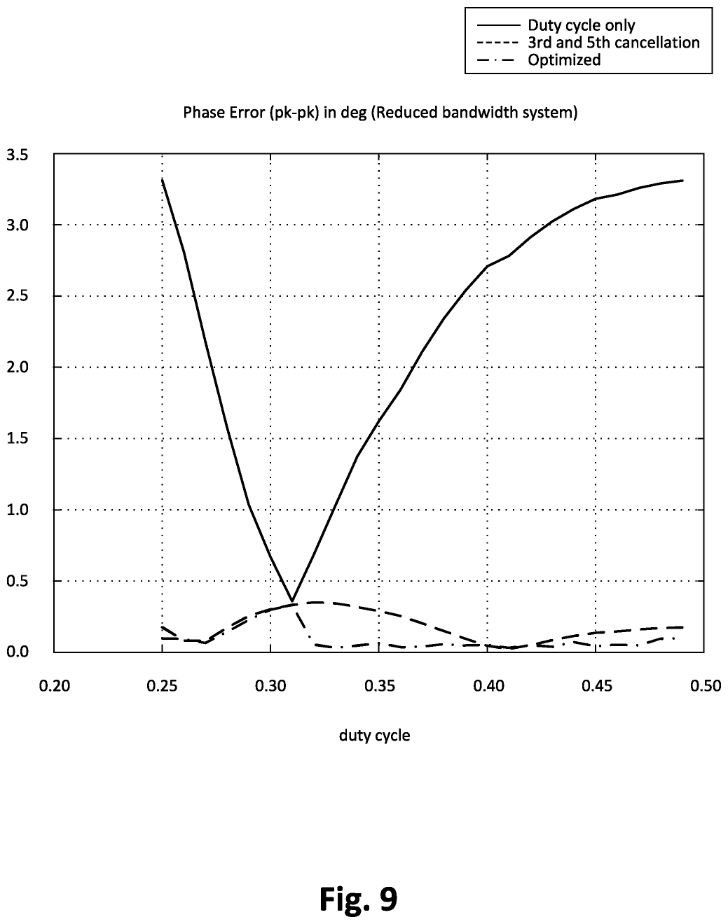

The graphs illustrated in FIGS. 5 to 9 illustrate model based simulation results related to the determination and optimization of the (cyclic) phase error (“cyclic error”) for different system bandwidth (“high bandwidth” and “reduced bandwidth”). By means of the model based simulation, for different duty cycles, the optimal parameters, phase offset Δϕ (FIG. 6) and component ratio c (FIG. 7), are obtained for the illumination modulation signal as presented in FIG. 3a and the resulting phase error for these optimal parameters (FIGS. 5 and 9) is determined and compared with simulation results of two conventional structures of illumination modulation signal, namely “duty cycle only” (standard acquisition phases 0°, 90°, 180°, 270°) and “another known method” (use of five acquisition phases) (FIGS. 5 and 9).

FIG. 5 graphically compares the phase error of the illumination modulation signal as presented in FIG. 3a with two conventional structures of illumination modulation signal, namely “duty cycle only” (standard acquisition phases 0°, 90°, 180°, 270°) and “another known method” (use of five acquisition phases) for the “high bandwidth” case. The graph of FIG. 5 shows the (cyclic) phase error (peak-to-peak), in degrees of 360° alias range in dependence of the duty cycle of the illumination modulation signal. FIG. 5 shows on the abscissa a duty cycle value from 20% to 50% and on the ordinate the phase error in degrees of 360° alias range from 0 to 10. The solid line L1 represents the phase error of a illumination modulation signal for the “duty cycle only” case. The dashed line L2 represents the phase error of an illumination modulation signal for the “another known method” case. The dotted-dashed line L3 represents the optimized phase error as obtained with the illumination modulation signal presented in FIG. 3a for an optimal phase offset Δϕ (see FIG. 6) and an optimal component ratio c (see FIG. 7) for the respective duty cycle. As can be obtained from the simulation results of FIG. 5, the optimized phase error (line L3) is lower than the phase error in the “duty cycle only” case (line L1) and the “another known method” case (line L2).

FIG. 6 illustrates a graph indicating, for a high bandwidth system and a reduced bandwidth system, the optimal phase offset for the compensation components (P1 and P2 in FIG. 3a) of the illumination modulation signal as presented in FIG. 3a in dependence of the duty cycle. FIG. 6 shows on the abscissa the duty cycle from 20% to 50% and on the ordinate the phase offset (Δϕ in FIG. 3a) from 0 to 80 degrees. The solid line L1 represents the optimal phase offset Δϕ for the respective duty cycle in the case of “high bandwidth system”. The dashed line L2 represents the optimal phase offset Δϕ for the respective duty cycle in the case of “reduced bandwidth system”.

FIG. 7 illustrates a graph indicating, for a high bandwidth system and a reduced bandwidth system, the optimal compensation ratio of the illumination modulation signal as presented in FIG. 3a in dependence of the duty cycle. FIG. 7 shows on the abscissa the duty cycle from 20% to 50% and on the ordinate the components ratio c from 0.2 to 2.0. The solid line L1 represents the optimal components ratio c for the respective duty cycle in the case of “high bandwidth system”. The dashed line L2 represents the optimal components ratio c for the respective duty cycle in the case of “reduced bandwidth system”.

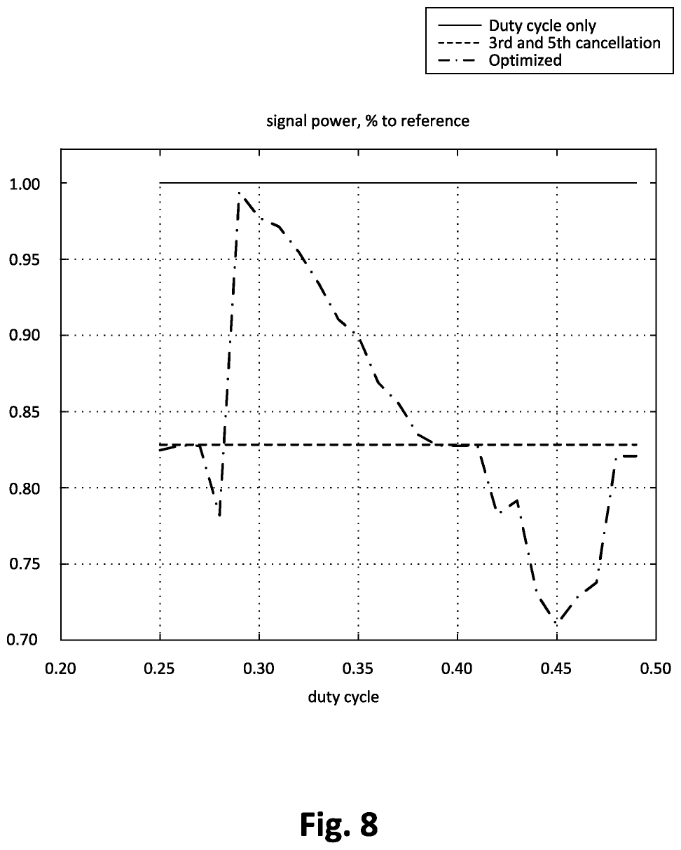

FIG. 8 graphically represents the signal power loss of the illumination modulation signal as presented in FIG. 3a and of the “another known method” (use of five acquisition phases) compared to the “duty cycle only” case (standard acquisition phases 0°, 90°, 180°, 270°). FIG. 8 shows on the abscissa a duty cycle value from 20% to 50% and on the ordinate relative signal power (in percent) compared to the “duty cycle only” case which acts as reference, in the range from 0.70 to 1.00. The solid line L1 (constantly 100%) represents the signal power of the “duty cycle only” case. The dashed line L2 represents the signal power loss of the “another known method” case. The dotted-dashed line L3 represents, for the respective duty cycles, the power loss of the illumination modulation signal as presented in FIG. 3a for an optimal phase offset (see FIG. 5) and an optimal component ratio (see FIG. 7). As it is shown in FIG. 8, the power loss for the optimized parameters (line L3) is remarkably less for duty cycles in a range from 29% to 36%, compared to the power loss in the “another known method” case (line L2).

FIG. 9 graphically compares the phase error of the illumination modulation signal as presented in FIG. 3a with two conventional structures of illumination modulation signal, namely “duty cycle only” and “another known method” for the “reduced bandwidth” case. The graph of FIG. 9 shows the phase error (peak-to-peak), in degrees of 360° alias range in dependence of the duty cycle of the illumination signal. FIG. 9 shows on the abscissa a duty cycle value from 20% to 50% and on the ordinate the phase error in degrees of 360° alias range from 0 to 10. The solid line L1 represents the phase error of an illumination modulation signal for the “duty cycle only” case. The dashed line L2 represents the phase error of an illumination modulation signal for the “another known method” case. The dotted-dashed line L3 represents the optimized phase error as obtained with the illumination modulation signal presented in FIG. 3a for an optimal phase offset Δϕ (see FIG. 6) and an optimal component ratio c (see FIG. 7) for the respective duty cycle. As can be obtained from the simulation results of FIG. 9, the optimized phase error (line L3) is lower than the phase error in the “duty cycle only” case (line L1) and the “another known method” case (line L2). As can be obtained from FIG. 9, in the “reduced bandwidth system” case when modulation frequency is comparable to the system bandwidth, higher order harmonics of the correlation waveform are attenuated, but even in this case the proposed method allows achieving lower cyclic errors.

FIG. 10 illustrates schematically, as another embodiment, a structure of a illumination modulation signal with four illumination waveform components with different phase offsets. The illumination modulation signal 203 comprises four illumination waveform components P11, P12, P13, P14. Each illumination waveform component P11, P12, P13, P14 is the sequence of the illumination light pulses with the repetition rate proportional to the selected modulation frequency and specific duty cycle, e.g. 35%, 33.3%, 31.25% or 30%. The illumination waveform component P11 has a duration of b and a phase offset of −Δϕ, the illumination waveform component P12 has a duration of

$$\frac{a}{2}$$

and no phase offset, the illumination waveform component P13 has a duration of b and a phase offset of +Δϕ and the illumination waveform component P14 has a duration of

$$\frac{a}{2}$$

and no phase offset. The phase offset may be for example ±36°, ±30°, ±22.5° or ±18°. As the illumination waveform components P12 and P14 have no phase offset, they correspond to the respective acquisition phase (e.g. 0°, 90°, 180°, 270°) or constant in case acquisition phases are applied in the pixel modulation mix signals. The illumination waveform components P11 and P13 (compensation components) are used for harmonic content reduction.

Thus, for S acquisition phases, the transmit delays t_{E} between the in-pixel reference signal (modulation signal) and the pixel irradiance signal Φ_{E}(t, τ_{E}, τ_{D}) based on the illumination modulation signal 203 as described in FIG. 10 are:

t_{E}=[τ_{E,0,ϕ}_{₀}_{-Δϕ},τ_{E,0,ϕ}_{₀},τ_{E,0,ϕ}_{₀}_{+Δϕ},τ_{E,0,ϕ}_{₀} . . . τ_{E,S-1,ϕ}_{₀}_{-Δϕ},τ_{E,S-1,ϕ}_{₀},τ_{E,S-1,ϕ}_{₀}_{+Δϕ},τ_{E,S-1,ϕ}_{₀}]^{T} (Eq. 27)

FIG. 11 illustrates schematically the resulting illumination modulation signal as obtained with the illumination modulation structure of FIG. 10. The illumination modulation signal 203 is modulated with a modulation frequency f_{M} at a reduced duty cycle of 25%. The illumination modulation signal is a periodical signal with period T_{M}=f_{M}⁻¹, f_{M} being the fundamental frequency or modulation frequency generated by the modulation clock (5 in FIG. 1). The phase modulation frequency according to this embodiment is ¼ of the modulation frequency f_{M} of the illumination signal, and Δϕ is the maximum phase deviation. That is, every second pulse of the illumination modulation signal is phase shifted by phase offset +Δϕ, or, respectively, −Δϕ. This can be expressed as an extra phase modulation of the illumination modulation signal (respectively, the resulting illumination signal/emitted light).

By optimizing the phase modulation frequency and the maximum phase deviation Δϕ, a comparable improvement of cyclic error reduction can be achieved.

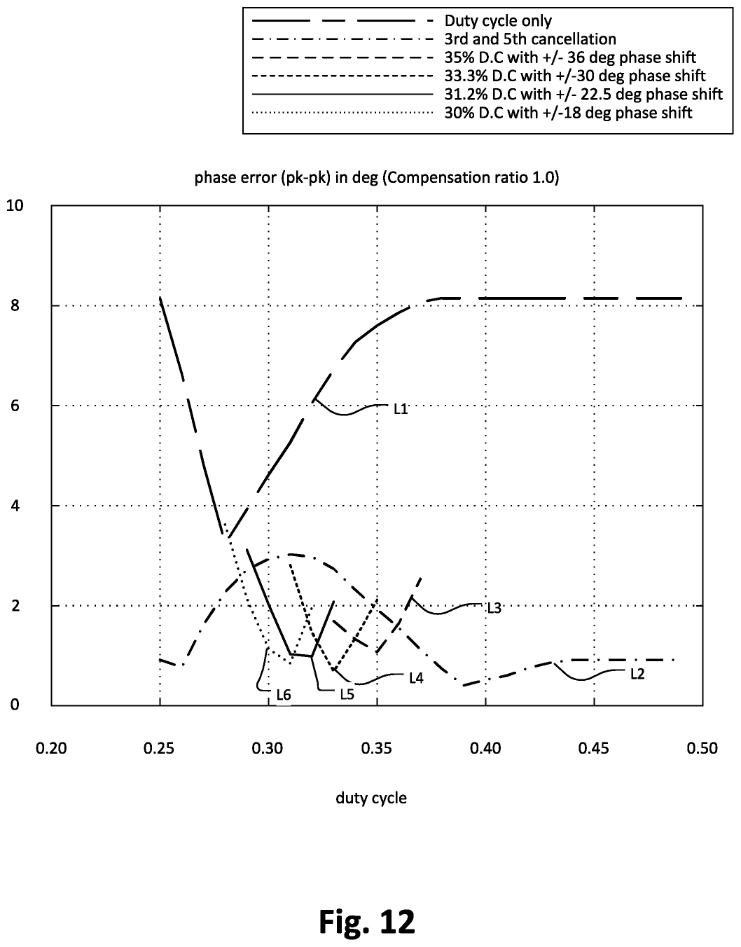

FIG. 11 graphically compares the optimized phase error of the illumination modulation signal as presented in FIG. 9 with two conventional structures of illumination modulation signal, namely “duty cycle only” (standard acquisition phases 0°, 90°, 180°, 270°) and “another known method” (use of five acquisition phases). In particular, FIG. 12 shows an optimized phase error obtained with duty cycle 35%, ±36° phase offset and compensation ratio of 1.0 (line L3), an optimized phase error obtained with duty cycle 33.3%, ±30° phase offset and compensation ratio of 1.0 (line L4), an optimized phase error (line L5) obtained with duty cycle 31.2%, ±22.5° phase offset and compensation ratio of 1.0, and an optimized phase error (line L6) obtained with duty cycle 30%, ±18° phase offset and compensation ratio of 1.0. Still further, FIG. 12 shows the phase error of two conventional structures of illumination modulation signal, namely “duty cycle only” (line L1) (standard acquisition phases 0°, 90°, 180°, 270°) and “another known method” (line L2) (use of five acquisition phases). The graph of FIG. 12 shows the phase error (peak-to-peak), in degrees of 360° alias range in dependence of the duty cycle of the illumination signal. FIG. 11 shows on the abscissa a duty cycle value from 20% to 50% and on the ordinate the phase error in degrees of 360° alias range from 0 to 10. As illustrated in FIG. 12, the optimized phase errors (lines L3 to L6) have a lower cyclic error compared to the phase error in the “duty cycle only” case (line L1) and the “another known method” case (line L2).

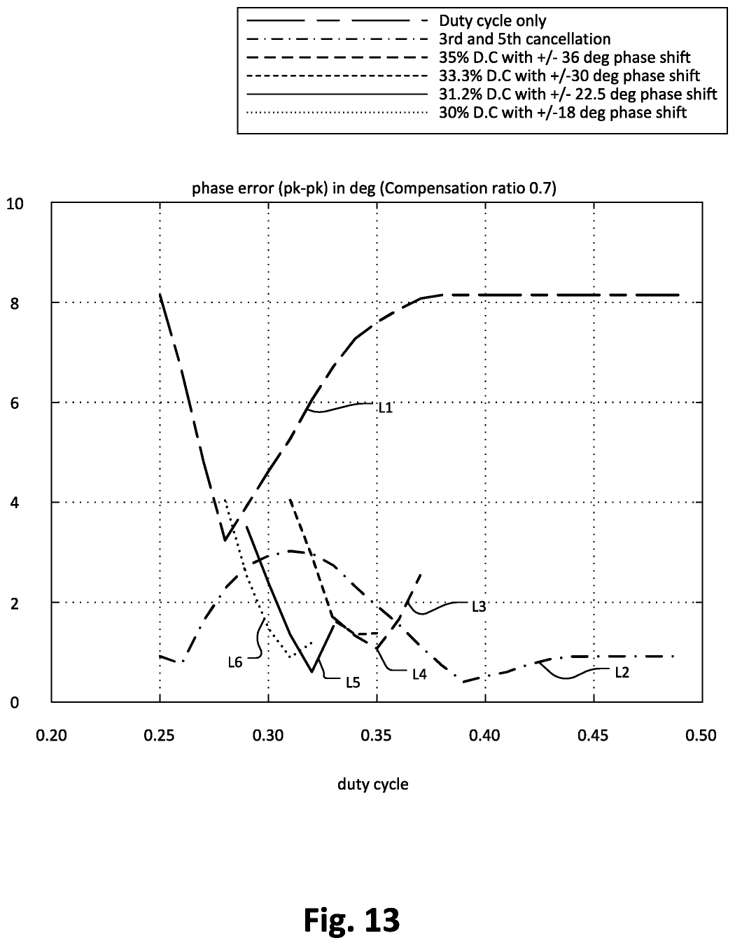

In FIG. 12 it can be found that for signal properties set for 33% duty cycle, ±30° phase offset and component ratio c=1 peak error increases from about 1° to more than 2° in case actual duty cycle is distorted and equal to 35%. However, this extra error due to the duty cycle distortion can be mitigated by more optimal component ratio c for example with 0.7 error is fully recovered to the value about 1° (see FIG. 13).

FIG. 13 graphically compares the optimized phase error of the illumination modulation signal as presented in FIG. 10 with two conventional structures of illumination modulation signal, namely “duty cycle only” (standard acquisition phases 0°, 90°, 180°, 270°) and “another known method” (use of five acquisition phases). In particular, FIG. 13 shows an optimized phase error obtained with duty cycle 35%, ±36° phase offset and compensation ratio of 0.7 (line L3), an optimized phase error obtained with duty cycle 33.3%, +30° phase offset and compensation ratio of 0.7 (line L4), an optimized phase error (line L5) obtained with duty cycle 31.2%, ±22.5° phase offset and compensation ratio of 0.7, and an optimized phase error (line L6) obtained with duty cycle 30%, ±18° phase offset and compensation ratio of 0.7. Still further, FIG. 12 shows the phase error of two conventional structures of illumination modulation signal, namely “duty cycle only” (line L1) (standard acquisition phases 0°, 90°, 180°, 270°) and “another known method” (line L2) (use of five acquisition phases). FIG. 13 shows on the abscissa a duty cycle value from 20% to 50% and on the ordinate signal power in percent compared to a reference signal, in the value from 0.70 to 1.00. As illustrated in FIG. 13, the optimized phase errors (lines L3 to L6) have a lower cyclic error compared to the phase error in the “duty cycle only” case (line L1) and the “another known method” case (line L2).

More particular, as it is shown in FIG. 13, the preferred duty cycle for the optimized phase errors (lines L3 to L6) lies in range 30 to 35%. The reasons, for example, are reasonable signal power loss, improved contrast and affordable impact on illumination system complexity.

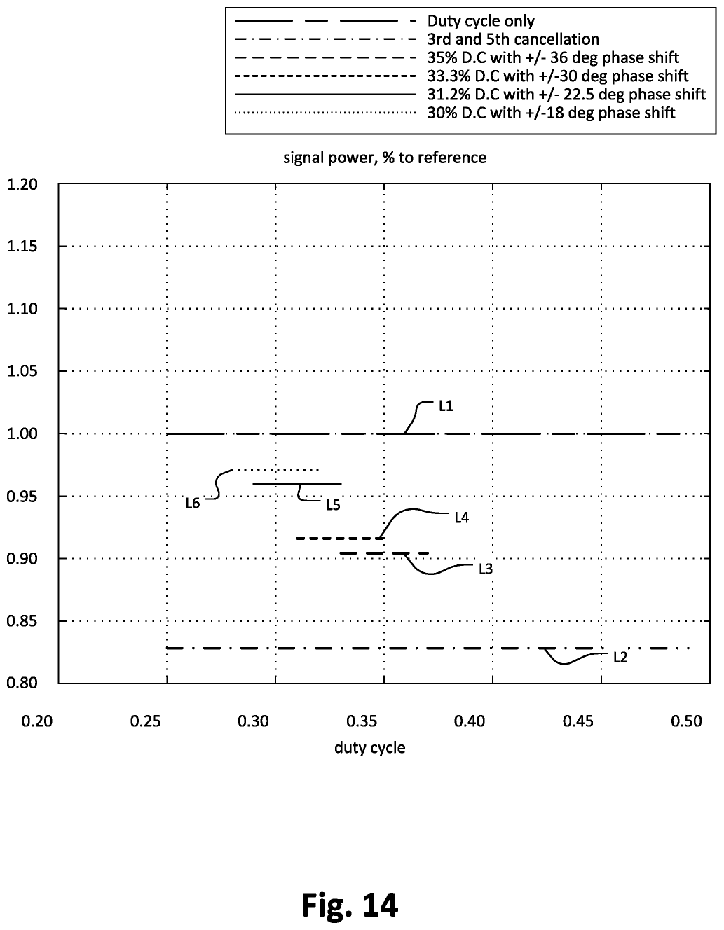

FIG. 14 graphically represents the signal power loss of the illumination modulation signal as presented in FIG. 10 and of the “another known method” (use of five acquisition phases) compared to the “duty cycle only” case (standard acquisition phases 0°, 90°, 180°, 270°). FIG. 14 shows on the abscissa a duty cycle value from 20% to 50% and on the ordinate relative signal power (in percent) compared to the “duty cycle only” case which acts as reference, in the range from 0.70 to 1.00. In particular, FIG. 14 shows the signal power (constantly 100%) of the “duty cycle only” case (line L1). Further, FIG. 14 shows a signal power loss of the optimized phase error with duty cycle 35% and ±36° phase offset (line L3), a signal power loss of the optimized phase error with duty cycle 33.3% and ±30° phase offset (line L4), a signal power loss of the optimized phase error with duty cycle 31.2% and ±22.5° phase offset (line L5), and a signal power loss of the optimized phase error with duty cycle 30% and ±18° phase offset. Still further, FIG. 14 shows the signal power loss of the “another known method” case (L2). As it is shown in FIG. 14, the power loss for the optimized parameters (lines L3 to L6) is still less compared to the power loss in the “another known method” case (line L2).

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

[1] Electronic device comprising circuitry configured to
generate, during an exposure time, an in-pixel reference signal (m(t); 201),
wherein the exposure time comprises one or more sub-exposures (203), each sub-exposure (203) comprising a set of multiple components (P1, P2, P3; P1, P2, P3, P4; P11, P12, P13, P14), each component having a respective predefined duration and each component providing a predefined acquisition phase;
wherein the set of multiple components comprises one or more basic components (P3; P4; P12, P14) providing a predefined basic acquisition phase (ϕ₀), and at least two additional components (P1, P2; P1, P2, P3; P11, P13) providing respective predefined additional acquisition phases, each additional acquisition phase having a respective phase offset (Δϕ) with respect to the basic acquisition phase (ϕ₀);
wherein the durations (bₙ) and the phase offsets (Δϕₙ) of the additional components (P1, P2; P1, P2, P3; P11, P13) are arranged such that, in total, the phase offsets (Δϕₙ) of the additional components compensate (P1, P2; P1, P2, P3; P11, P13) each other.

[2] Electronic device of [1], wherein the durations (bₙ) and the phase offsets (Δϕₙ) of the additional components (P1, P2; P1, P2, P3; P11, P13) are arranged such that the sum of each phase offset multiplied with each respective duration is zero.

[3] Electronic device of [1 or [2]], wherein the durations (bₙ) and the phase offsets (Δϕₙ) of the additional components are arranged such that an effective acquisition phase during the exposure time corresponds to the predefined basic acquisition phase (ϕ₀).

[4] Electronic device anyone of [1] to [3], wherein the circuitry is further configured to generate the in-pixel reference signal (m(t); 201) with a predefined duty cycle, and to generate the illumination modulation signal (203) with a duty cycle that is reduced compared to the duty cycle of the in-pixel reference signal (m(t); 201).

[5] Electronic device anyone of [1] to [4], wherein the circuitry is further configured to generate emitted light (Φ_{E}(t−τ_{E}); 16) based on the illumination modulation signal (203).

[6] Electronic device of [2], wherein the circuitry is further configured to sample a correlation waveform (22, 23) based on the reference signal (m(t); 201) and a reflected light signal (Φ_{R}(t, τ_{E}, τ_{D}); 17), wherein the reflected light signal (Φ_{R}(t, τ_{E}, τ_{D}); 17) is a scaled and delayed version of the emitted light (Φ_{E}(t−τ_{E}); 16).

[7] Electronic device anyone of [1] to [6], wherein the exposure time comprises multiple sub-exposures (203), each sub-exposure (203) comprising a set of multiple components (P1, P2, P3; P1, P2, P3, P4; P11, P12, P13, P14), wherein each respective set of multiple components comprises one or more basic components (P3; P4; P12, P14) providing a predefined basic acquisition phase (ϕ₀) associated with the respective sub-exposure (203), and at least two additional components (P1, P2; P1, P2, P3; P11, P13) associated with each sub-exposure (203).

[8] The electronic device anyone of [1] to [7], wherein the component ratio of the modulation signal (203) is given as:

$$c = \frac{{Σ}_{n = 1}^{M} {a}_{n}}{{Σ}_{n = 1}^{N} {b}_{n}} ,$$

where c is the component ratio, M is number of basic components, aₙ is the duration of the respective basic components, N is number of additional components, Loₙ is the duration of the respective additional components, wherein the component ratio is from 0.2 to 2.

[9] The electronic device according to [4], wherein the duty cycle of the illumination modulation signal (203) is in range of 25 to 50%.

[10] The electronic device according to [4], wherein the duty cycle of the illumination modulation signal (203) is in range of 29 to 36%.

[11] The electronic device according to anyone of [1] to [10], wherein the phase offset (Δϕ) of the additional components (P1, P2; P1, P2, P3; P11, P13) are in a range from 9° to 50°.

[12] The electronic device according to anyone of [1] to [12], wherein the additional components comprise:
a first additional component (P1) with a phase (ϕ₀+Δϕ) shifted from the basic acquisition phase (ϕ₀) with a positive phase offset (+Δϕ), and
a second component (P2) with a phase (ϕ₀−Δϕ) shifted from the phase (ϕ₀) of the first component (P3) with a negative phase offset (−Δϕ).

[13] The electronic device according to anyone of [1] to [12], wherein the illumination modulation signal (203) is phase modulated.

[14] The electronic device according to [11], wherein the phase modulation frequency is smaller than the modulation frequency (f_{M}) of the illumination modulation signal (203).

[15] The electronic device according to anyone of [1] to [14], wherein the sub-exposure comprises:
a first basic component (P12) with a phase (ϕ₀) that corresponds to the basic acquisition phase (ϕ₀),
a second basic component (P14) with a phase (ϕ₀) that corresponds to the basic acquisition phase (ϕ₀),
a first additional component (P11) with a phase (ϕ₀−Δϕ) shifted from the phase (ϕ₀) of the first component (P12) with a negative phase offset (−Δϕ), and
a second additional component (P13) with a phase (ϕ₀+Δϕ) shifted from the basic acquisition phase (ϕ₀) with a positive phase offset (+Δϕ).

[16] A time of flight camera (3) comprising the circuitry anyone of [1] to [15].

[17] A method comprising:
generating, during an exposure time, an in-pixel reference signal (m(t); 201),
wherein the exposure time comprises one or more sub-exposures (203), each sub-exposure (203) comprising a set of multiple components (P1, P2, P3; P1, P2, P3, P4; P11, P12, P13, P14), each component having a respective predefined duration and each component providing a predefined acquisition phase;
wherein the set of multiple components comprises one or more basic components (P3; P4; P12, P14) providing a predefined basic acquisition phase (ϕ₀), and at least two additional components (P1, P2; P1, P2, P3; P11, P13) providing respective predefined additional acquisition phases, each additional acquisition phase having a respective phase offset (Δϕ) with respect to the basic acquisition phase (ϕ₀);

wherein the durations (bₙ) and the phase offsets (Δϕₙ) of the additional components (P1, P2; P1, P2, P3; P11, P13) are arranged such that, in total, the phase offsets (Δϕₙ) of the additional components compensate (P1, P2; P1, P2, P3; P11, P13) each other.

1. Electronic device comprising circuitry configured to
generate, during an exposure time, an in-pixel reference signal,
wherein the exposure time comprises one or more sub-exposures, each sub-exposure comprising a set of multiple components, each component having a respective predefined duration and each component providing a predefined acquisition phase;
wherein the set of multiple components comprises one or more basic components providing a predefined basic acquisition phase, and at least two additional components providing respective predefined additional acquisition phases, each additional acquisition phase having a respective phase offset with respect to the basic acquisition phase;
wherein the durations and the phase offsets of the additional components are arranged such that, in total, the phase offsets of the additional components compensate each other.

2. Electronic device of claim 1, wherein the durations and the phase offsets of the additional components are arranged such that the sum of each phase offset multiplied with each respective duration is zero.

3. Electronic device of claim 1, wherein the durations and the phase offsets of the additional components are arranged such that an effective acquisition phase during the exposure time corresponds to the predefined basic acquisition phase.

4. Electronic device of claim 1, wherein the circuitry is further configured to generate the in-pixel reference signal with a predefined duty cycle, and to generate the illumination modulation signal with a duty cycle that is reduced compared to the duty cycle of the in-pixel reference signal.

5. Electronic device of claim 1, wherein the circuitry is further configured to generate emitted light based on the illumination modulation signal.

6. Electronic device of claim 2, wherein the circuitry is further configured to sample a correlation waveform based on the reference signal and a reflected light signal, wherein the reflected light signal is a scaled and delayed version of the emitted light.

7. Electronic device of claim 1, wherein the exposure time comprises multiple sub-exposures, each sub-exposure comprising a set of multiple components, wherein each respective set of multiple components comprises one or more basic components providing a predefined basic acquisition phase associated with the respective sub-exposure, and at least two additional components associated with each sub-exposure.

8. The electronic device of claim 1, wherein the component ratio of the modulation signal is given as:
$$c = \frac{{Σ}_{n = 1}^{M} {a}_{n}}{{Σ}_{n = 1}^{N} {b}_{n}} ,$$
where c is the component ratio, M is number of basic components, aₙ is the duration of the respective basic components, N is number of additional components, bₙ is the duration of the respective additional components, wherein the component ratio is from 0.2 to 2.

9. The electronic device according to claim 4, wherein the duty cycle of the illumination modulation signal is in range of 25 to 50%.

10. The electronic device according to claim 4, wherein the duty cycle of the illumination modulation signal is in range of 29 to 36%.

11. The electronic device according to claim 1, wherein the phase offset of the additional components are in a range from 9° to 50°.

12. The electronic device according to claim 1, wherein the additional components comprise:
a first additional component with a phase shifted from the basic acquisition phase with a positive phase offset, and
a second component with a phase shifted from the phase of the first component with a negative phase offset.

13. The electronic device according to claim 1, wherein the illumination modulation signal is phase modulated.

14. The electronic device according to claim 11, wherein the phase modulation frequency is smaller than the modulation frequency of the illumination modulation signal.

15. The electronic device according to claim 1, wherein the sub-exposure comprises:
a first basic component with a phase that corresponds to the basic acquisition phase,
a second basic component with a phase that corresponds to the basic acquisition phase,
a first additional component with a phase shifted from the phase of the first component with a negative phase offset, and
a second additional component with a phase shifted from the basic acquisition phase with a positive phase offset.

16. A time of flight camera comprising the circuitry of claim 1.

17. A method comprising:
generating, during an exposure time, an in-pixel reference signal,
wherein the exposure time comprises one or more sub-exposures, each sub-exposure comprising a set of multiple components, each component having a respective predefined duration and each component providing a predefined acquisition phase;
wherein the set of multiple components comprises one or more basic components providing a predefined basic acquisition phase, and at least two additional components providing respective predefined additional acquisition phases, each additional acquisition phase having a respective phase offset with respect to the basic acquisition phase;
wherein the durations and the phase offsets of the additional components are arranged such that, in total, the phase offsets of the additional components compensate each other.
